(19) United States
(12) Patent Application Publication
(10) Pub. No.: US 2008/0082712 A1
(43) Pub. Date: Apr. 3, 2008

(54) COMPUTER SYSTEM AND CONTROL METHOD THEREOF

(75) Inventor: Sung-geun JOO, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/773,166

(22) Filed: Jul. 3, 2007

(30) Foreign Application Priority Data
Sep. 29, 2006 (KR) 2006-96254

(51) Int. Cl. G06F 13/24

(52) U.S. Cl. 710/260

(57) ABSTRACT

A computer system and a control method of the same. The computer system includes a user input unit and a controller. The controller cancels a shutdown of the computer system if a shutdown cancellation command is inputted through the user input unit while at least one of the application program and the operating system is being shut down by a shutdown command inputted through the user input unit.

### CROSS-REFERENCE TO RELATED APPLICATIONS

This application claims the benefit of Korean Patent Application No. 2006-96254, filed on Sep. 29, 2006, in the Korean Intellectual Property Office, the disclosure of which is incorporated herein by reference.

### BACKGROUND OF THE INVENTION

1. Field of the Invention

Aspects of the present invention relate to a computer system and a control method thereof and, more particularly, to a computer system that cancels shutdown during a shutdown process of the computer system and re-executes the computer system and a control method thereof.

2. Description of the Related Art

When a system shutdown command is inputted, a computer system first shuts down all application programs in operation and then runs a shutdown process of an operating system to prevent a malfunction due to power-off. The computer system turns itself off at the end of the shutdown process. While using a conventional computer system, a user may unintentionally input a system shutdown command and lose unsaved documents. The user may not be allowed to cancel the system shutdown after inputting the system shutdown command.

### SUMMARY OF THE INVENTION

Aspects of the present invention provide a computer system that cancels a shutdown process and re-executes the computer system and a control method thereof.

Other aspects of the present invention provide a computer system that executes a different system re-execution process according to a shutdown timing of either an application program or an operating system and a control method thereof.

Additional aspects and/or advantages of the present invention will be set forth in part in the description which follows and, in part, will be obvious from the description, or may be learned by practice of the present invention.

According to an aspect of the present invention, a computer system is provided that executes an application program based on an operating system, the computer system comprising a user input unit to receive a user's command; and a controller to cancel a shutdown of the computer system if a shutdown cancellation command is inputted through the user input unit while at least one of the application program and the operating system is being shut down by a shutdown command inputted through the user input unit.

According to another aspect of the invention, the computer system further comprises a storage unit to store a shutdown cancellation mode to cancel the shutdown of the computer system, wherein the controller cancels the shutdown of the computer system according to the shutdown cancellation mode if the shutdown cancellation command is inputted through the user input unit.

According to another aspect of the invention, the controller stores, in the storage unit, setting information related to the shutdown cancellation mode inputted through the user input unit.

According to another aspect of the invention, the computer system further comprises a display unit, wherein the controller displays a setting screen of the shutdown cancellation mode on the display unit to receive the setting information related to the shutdown cancellation mode through the user input unit.

According to another aspect of the invention, the controller stops shutting down the application program if the shut down cancellation command is inputted while the application program is being shut down.

According to another aspect of the invention, the controller re-executes the application program if a re-execution command of the application program is inputted through the user input unit.

According to another aspect of the invention, the controller shuts down the application program if the re-execution command of the application program is not inputted through user input unit.

According to another aspect of the invention, the controller executes a start program relating to the application program after reading the start program from an application configuration files stored in the storage unit.

According to another aspect of the invention, the controller re-executes the operating system if the shutdown cancellation command is inputted while the operating system is being shut down.

According to another aspect of the invention, the computer system further comprises a plurality of components, wherein the controller reads a setting value related to each of the devices from a registry stored in the storage unit to set the respective components.

According to another aspect of the invention, the user input unit comprises a power switch to receive the shutdown cancellation command from the user.

According to another aspect of the invention, the controller consecutively stores system processes executed according to the shutdown command inputted through the user input unit and restores the computer system according to the stored system processes if the shutdown cancellation command is inputted.

According to another aspect of the present invention, a method of controlling a computer system that executes an application program and an operating system is provided, the method comprising executing a shutdown of the computer system by a shutdown command; and canceling the shutdown of the computer system if a shutdown cancellation command is inputted while at least one of the application program and the operating system is being shut down.

According to another aspect of the invention, the method further comprises storing a shutdown cancellation mode to cancel the shutdown of the computer system, wherein the canceling the shutdown of the computer system comprises canceling the shutdown of the computer system according to a shutdown cancellation mode if the shut down cancellation command is inputted.

According to another aspect of the invention, the storing the shutdown cancellation mode further comprises displaying a setting screen of the shutdown cancellation mode.

According to another aspect of the invention, the storing the shutdown cancellation mode further comprises storing setting information related to the shutdown cancellation mode.

According to another aspect of the invention, the canceling the shutdown of the computer system comprises stopping the shutting down of the application program if the shutdown cancellation command is inputted while the application program is being shut down.

According to another aspect of the invention, the canceling the shutdown of the computer system further comprises stopping the shutting down of the application program and displaying a re-execution menu of the application program.

According to another aspect of the invention, the canceling the shutdown of the computer system further comprises re-executing the application program if a re-execution command of the application program is inputted.

According to another aspect of the invention, the canceling the shutdown of the computer system further comprises executing the shutdown of the application program if the re-execution command of the application program is not inputted.

According to another aspect of the invention, the canceling the shutdown of the computer system further comprises executing a start program relating to the application program after reading the start program from an application configuration file.

According to another aspect of the invention, the canceling the shutdown of the computer system further comprises re-executing the operating system if the shut down cancellation command is inputted while the operating system is being shut down.

According to another aspect of the invention, the re-executing the operating system comprises reading a setting value related to a device from a registry stored in the storage unit and setting the device based on the setting value.

According to an aspect of the invention, the canceling the shutdown of the computer system comprises consecutively storing system processes executed according to the shutdown command and restoring the computer system according to the stored system processes if the shut down cancellation command is inputted.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a block diagram of a computer system according to an embodiment of the present invention;

FIG. 2 is a flowchart of a shutdown cancellation mode of the computer system according to an embodiment of the present invention;

FIG. 3 is a flowchart of a control method of the computer system according to an embodiment of the present invention;

FIG. 4 illustrates an example of a shutdown cancellation mode setting screen which is realized by an embodiment of the present invention; and

FIG. 5 illustrates an example of a system shutdown menu screen which is realized by an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

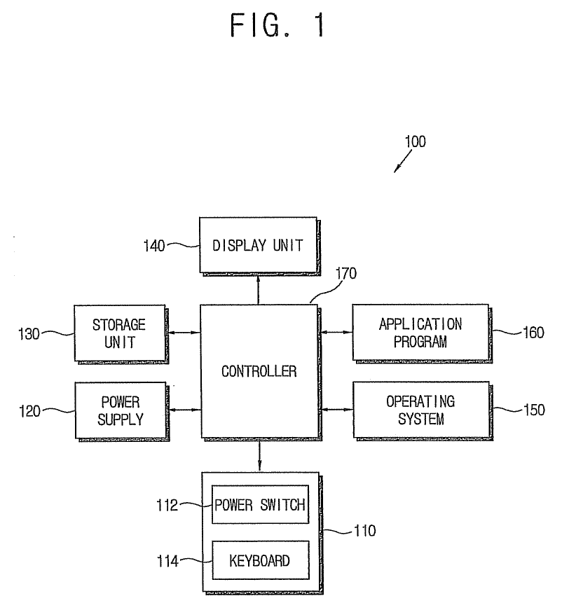

FIG. 1 is a block diagram of a computer system according to an embodiment of the present invention. A computer system 100 comprises a user input unit 110, a power supply 120, a storage unit 130, a display unit 140, an operating system 150, an application program 160 and a controller 170. According to other aspects of the present invention, the computer system 100 may contain other units as well. The computer system 100 may be a desktop computer system or a mobile computer system.

The user input unit 110 receives a system shutdown command and a system shutdown cancellation command from a user and transmits the commands to the controller 170. The user input unit 110 may include a power switch 112 to operate the power supply 120 that supplies power to the computer system 100, a keyboard 114 to input data, and/or a mouse (not shown) to move a cursor and/or to input a command. The user input unit 112 may be any type of input device. The power switch 112 may be used to input the system shutdown cancellation command. If the power switch 112 is operated again while the controller 170 is shutting down the computer system 100 according to the system shutdown command, the controller 170 may interpret the additional operation as a system shutdown cancellation command and may cancel the shutdown process of the computer system 100. A key, mouse-click, keystroke, or any combination thereof may be configured to be used to input the system shutdown cancellation command.

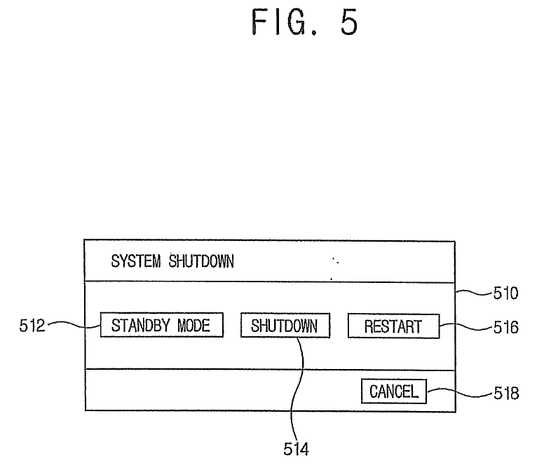

The power supply 120 supplies power to a plurality of components within the computer system 100. When a user turns on the power switch 112 to run the computer system 100, the controller 170 receives a system-on command to control the power supply 120 to generate power to be supplied to the plurality of components. During operation of the computer system, if a user turns off the power switch 112 or the system shutdown command is inputted, for example, through a system shutdown menu 510 (such as the menu shown in FIG. 5), the controller 170 controls the power supply 120 to cut off the power supplied to the components of the computer system after first shutting down the application program 160 in operation and then shutting down the operating system 150.

The storage unit 130 stores the operating system 150 and the application program 160. The storage unit 130 also stores a shutdown cancellation mode to cancel the shutdown of the computer system 100. The shutdown cancellation mode comprises a process to cancel the shutdown process of the computer system 100 and to re-execute the computer system 100 when the shutdown cancellation command is inputted through the user input unit 110 while at least one of the application program 160 and the operating system 150 is being shut down.

When a user inputs the shutdown cancellation command while the application program 160 is being shut down, the storage unit 130 stores a process to stop shutting down the application program 160, a process to display on the display unit 140 a screen asking whether to re-execute the application program 160, and a process to re-execute the application program 160 if the re-execution command of the application program 160 is inputted through the user input unit 110.

When a user inputs the shutdown cancellation command while the operating system 150 is being shut down, the storage unit 130 stores a process to re-execute the operating system 150 and another process to set the devices by reading setting values relating to the plurality of devices from a registry stored in the storage unit 130. The storage unit 130 stores setting information related to the shutdown cancellation mode inputted through the user input unit 110. The shutdown cancellation mode may comprise a program which stores system processes in a series according to the shutdown command inputted through the user input unit 110 and restores the computer system consecutively according to the stored system processes if the shutdown cancellation command is inputted.

The display unit 140 displays information for a user according to a control of the controller 170. The display unit comprises a display, such as a Cathode Ray Tube (CRT) display, a Liquid Crystal Display (LCD) or a Plasma Display Panel (PDP).

The operating system 150 lies between the computer hardware and the application program 160 and enables the application program 160 to use the hardware without difficulty and manages hardware and software resources to maximize the overall efficiency of the computer system 100. The operating system 150 provides services to allow the user and the application program 160 to use the hardware and other software. Typically, the operating system 150 manages processes, memory, and input and output services.

The application program 160 is a program provided to solve a problem or for specific tasks. Occasionally, the application program 160 is operated by a user. These days, however, the application program 160 is often designed to ease difficulties in programming by the user and to be used conveniently. The application program 160 may be a word processing program, such as Microsoft Word; a spreadsheet program, such as Microsoft Excel; or other kinds of programs.

If a user inputs a command through the user input unit 110, the controller 170 executes the operating system 150 or the application program 160 according to a programmed process based on the user's command. The system shutdown cancellation mode may be programmed into the operating system 150.

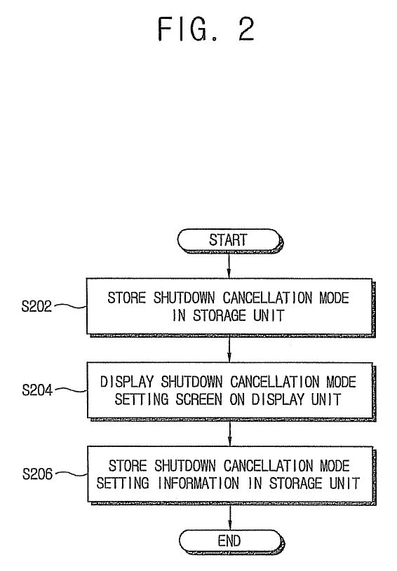

FIG. 2 is a flowchart of the shutdown cancellation mode of the computer system according to an embodiment of the present invention. The storage unit 130 stores the programmed process relating to the operation of the shutdown cancellation mode by the controller 170 or the operating system 150 of the computer system 100 (S202). The shutdown cancellation mode comprises a process to cancel the system shutdown and re-execute the operating system 150 or the application program 160 if the shutdown cancellation command is input by the user.

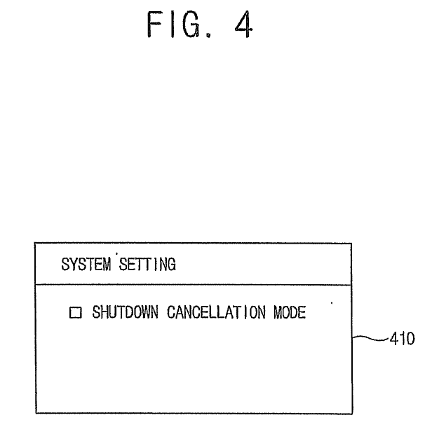

The controller 170 may further control a process to determine whether to activate the shutdown cancellation mode if the storage unit 130 stores the shutdown cancellation mode. If the storage unit 130 stores the shutdown cancellation mode, the controller 170 may set the computer system to operate the shutdown cancellation mode as a default value. The shutdown cancellation mode may also be programmed so that a user sets the operation of the shutdown cancellation mode. The controller 170 displays a setting screen 410 (shown in FIG. 4) of the shut down cancellation mode on the display unit 140 (S204). The controller 170 stores the setting information related to the system shutdown cancellation mode according to a user's selection in the storage unit 130 (S206). If a user selects the shutdown cancellation mode, the controller 170 stores the user's selection in the storage unit 130 and operates the shutdown cancellation mode. When a user inputs the system shutdown cancellation command, the controller 170 controls the computer system 100 to operate according to the shutdown cancellation mode. If a user does not select the shutdown cancellation mode, the controller 170 does not operate the shutdown cancellation mode and the controller 170 does not cancel the shutdown.

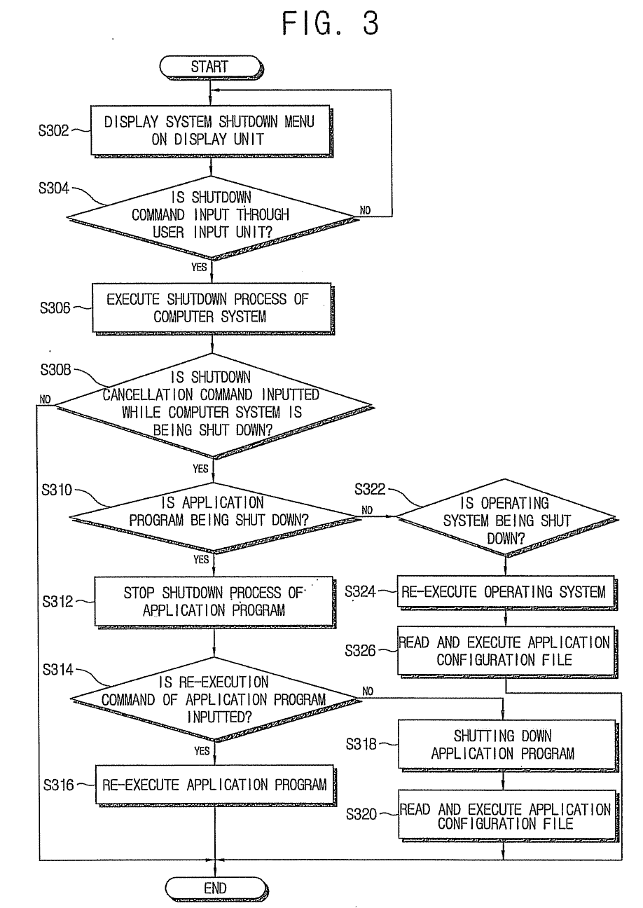

FIG. 3 is a flowchart of a shutdown cancellation routine according to an embodiment of the present invention. The controller 170 displays a system shutdown menu 510 (shown in FIG. 5) on the display unit 140 if a user inputs the system power-off command while the application program 160 is executing (S302). If the user clicks a shutdown button 514 displayed on the system shut down menu 510, the controller 170 determines that the system shut down command is inputted through the user input unit 110 (S304) and executes the shutdown mode of the computer system 100 (S306). If the system shutdown command is not inputted through the user input unit 110, the controller 170 operates the computer system 100 according to a command inputted through the user input unit 110.

The controller 170 checks whether a user has inputted the shutdown cancellation command (S308). If the power switch 112 or a button of the keyboard 114 designated for the system shutdown cancellation command is activated, the controller 170 determines that the system shutdown cancellation command has been inputted and cancels the system shutdown mode.

The controller 170 determines whether the shutdown cancellation command has been inputted while the application program 160 is being shut down (S310). If it is determined that the shutdown cancellation command has been inputted during the shutdown of the application program 160, the controller 160 stops shutting down the application program 160 (S312). The controller 170 displays on the display unit 140 a screen to ask about re-execution of the application program 160 and to receive a re-execution command of the application program 160. If a user chooses to re-execute the application program 160 displayed on the display unit 140, the controller 170 receives the re-execution command of the application program 160 (S314).

If the re-execution command of the application program 160 is inputted, the controller 170 re-executes the application program 160, shut down of which is now stopped (S316). For example, if the shutdown cancellation is activated while Microsoft Word, one of the application programs 160, is shutting down, the controller 170 re-executes Microsoft Word so that a user can perform word processing again. The controller 170 executes files stored in a start program relating to the application program 160 after reading them from an application configuration file (MSCONFIG) stored in the storage unit 130 (S320). If a user does not choose to re-execute the application program 160, the controller 170 resumes the shutdown of the application program 160.

If the shutdown cancellation command is not input while the application program 160 is shutting down, the controller 170 determines whether the command was inputted during the shutdown of the operating system 150 (S322). If it is determined that the shutdown cancellation command was inputted during the shutdown of the operating system 150, the controller 170 re-executes the operating system 150. The controller 170 executes files stored in a start program relating to the application program 160 after reading them from an application configuration file (MSCONFIG) stored in the storage unit 130.

If the shutdown command of the computer system 100 is inputted through the user input unit 110, the system processes to shut down the computer system are consecutively stored according to the shutdown command. Then, if the shutdown cancellation command is inputted, the operating system 150 and the application program 160 may be restored according to the stored system processes.

Shutdown cancellation techniques according to aspects of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like; and a computer data signal embodied in a carrier wave comprising a compression source code segment and an encryption source code segment (such as data transmission through the Internet). Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

As described above, aspects of the present invention provide a computer system that cancels shutdown during a shutdown process of the computer system and re-executes the computer system and a control method thereof.

Also, aspects of the present invention provide a computer system that re-executes the system differently according to the shutdown timing of either an application system or an operating system.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A computer system that executes an application program based on an operating system, the computer system comprising:
a user input unit to receive a user's command; and
a controller to cancel a shutdown of the computer system if a shutdown cancellation command is inputted through the user input unit while at least one of the application program and the operating system is being shut down by a shutdown command inputted through the user input unit.

2. The computer system according to claim 1, further comprising:
a storage unit to store a shutdown cancellation mode to cancel the shutdown of the computer system;
wherein the controller cancels the shutdown of the computer system according to the shutdown cancellation mode if the shutdown cancellation command is inputted through the user input unit.

3. The computer system according to claim 2, wherein the controller stores, in the storage unit, setting information related to the shutdown cancellation mode inputted through the user input unit.

4. The computer system according to claim 3, further comprising:
a display unit;
wherein the controller displays a setting screen of the shutdown cancellation mode on the display unit to receive the setting information related to the shutdown cancellation mode through the user input unit.

5. The computer system according to claim 1, wherein the controller stops shutting down the application program if the shut down cancellation command is inputted while the application program is being shut down.

6. The computer system according to claim 5, wherein the controller re-executes the application program if a re-execution command of the application program is inputted through the user input unit.

7. The computer system according to claim 5, wherein the controller shuts down the application program if the re-execution command of the application program is not inputted through the user input unit.

8. The computer system according to claim 7, wherein the controller executes a start program relating to the application program after reading the start program from application configuration files stored in the storage unit.

9. The computer system according to claim 1, wherein the controller re-executes the operating system if the shutdown cancellation command is inputted while the operating system is being shut down.

10. The computer system according to claim 9, further comprising:
a plurality of components;
wherein the controller reads a setting value related to each of the components from a registry stored in the storage unit to set the respective components.

11. The computer system according to claim 1, wherein the user input unit comprises a power switch to receive the shutdown cancellation command from the user.

12. The computer system according to claim 1, wherein the controller consecutively stores system processes executed according to the shutdown command inputted through the user input unit and restores the computer system according to the stored system processes if the shutdown cancellation command is inputted.

13. A method of controlling a computer system that executes an application program and an operating system, the method comprising:
executing a shutdown of the computer system by a shutdown command inputted by a user; and
cancelling the shutdown of the computer system if a shutdown cancellation command is inputted while at least one of the application program and the operating system is being shut down.

14. The method according to claim 13, further comprising:
storing a shutdown cancellation mode to cancel the shutdown of the computer system;
wherein the canceling the shutdown of the computer system comprises canceling the shutdown of the computer system according to a shutdown cancellation mode if the shut down cancellation command is inputted.

15. The method according to claim 14, wherein the storing the shutdown cancellation mode further comprises displaying a setting screen of the shutdown cancellation mode.

16. The method according to claim 15, wherein the storing the shutdown cancellation mode further comprises storing setting information related to the shutdown cancellation mode.

17. The method according to claim 13, wherein the canceling the shutdown of the computer system comprises stopping the shutting down of the application program if the shutdown cancellation command is inputted while the application program is being shut down.

18. The method according to claim 17, wherein the canceling the shutdown of the computer system further comprises stopping the shutting down of the application program and displaying a re-execution menu of the application program.

19. The method according to claim 18, wherein the canceling the shutdown of the computer system further comprises re-executing the application program if a re-execution command of the application program is inputted.

20. The method according to claim 19, wherein the canceling the shutdown of the computer system further comprises executing the shutdown of the application program if the re-execution command of the application program is not inputted.

21. The method according to claim 20, wherein the canceling the shutdown of the computer system further comprises executing a start program relating to the application program after reading the start program from an application configuration file.

22. The method according to claim 13, wherein the canceling the shutdown of the computer system further comprises re-executing the operating system if the shut down cancellation command is inputted while the operating system is being shut down.

23. The method according to claim 22, wherein the re-executing the operating system comprises:
reading a setting value related to a device from a registry; and
setting the device based on the setting value.

24. The method according to claim 13, wherein the canceling the shutdown of the computer system comprises consecutively storing system processes executed according to the shutdown command and restoring the computer system according to the stored system processes if the shut down cancellation command is inputted.

25. A computer, comprising:
a controller to execute a shut down process to shut down the computer in response to a first command and to execute a cancellation process to abort the shut down of the computer in response to a second command from a user.

26. The computer according to claim 25, wherein the controller executes different cancellation processes depending on the shutdown timing of an application program and/or an operating system.

27. A method comprising:
executing a shutdown process for a computer;
cancelling the shutdown process based upon a user command to cancel the shutdown process; and
restoring the computer to normal operations.

28. The method according to claim 27, wherein the restoring the computer to normal operations comprises re-executing an application that was running when execution of the shutdown process began.

29. The method according to claim 27, wherein the restoring the computer to normal operations comprises executing a plurality of stored processes in a predetermined order.

30. The method according to claim 27, wherein the cancelling of the shutdown process occurs while an application program and/or an operating system is running.
